(19) United States
(12) Patent Application Publication
(10) Pub. No.: US 2018/0027887 A1
(43) Pub. Date: Feb. 1, 2018

(54) PRAYER WEAR

(71) Applicant: TREVOR WALLACE, Sunrise, FL (US)

(72) Inventor: TREVOR WALLACE, Sunrise, FL (US)

(21) Appl. No.: 15/224,023

(22) Filed: Jul. 29, 2016

(51) Int. Cl. A41D 1/00; B43L 1/00; A41B 1/18

(52) U.S. Cl. CPC A41D 1/00; A41B 1/18; B43L 1/00

(57) ABSTRACT

An article of apparel comprising an upper body garment, the garment having a body, the body having a lower opening and an upper opening wherein the lower opening providing access for a human upper body to enter within the upper body garment, the upper opening being narrower than the lower body, wherein the upper opening allowing only the head to protrude out of the upper body garment,
the upper body garment having an outer surface and an inner surface, the outer surface forming the exterior of the upper body garment, the inner surface making contact with the human body when worn, the inner surface having a front and a rear surface, the rear outer surface; and
a prayer, spiritual or religious message printed on the outside back of the upper body garment, wherein the prayer, spiritual or religious message is printed in an orientation that can be read from left to right.

### BACKGROUND OF THE INVENTION

### 1. Field of the Invention

Embodiments of the present invention generally relate to a method of providing inspirational expressions on apparel, and more particularly to apparel with spiritual and religious expressions.

### 2. Description of the Related Art

People seem to have an inherent need to express themselves. In recent years, there has been a growing trend in the garment industry to provide wearing apparel with messages. This pertains to novelty garments such as T-shirts, caps, jackets or the like on which may be printed pictures, slogans, logos, messages, indicia, or any combination thereof. The applicant uses a distinct method of gaining attention. Additionally, ordinary wearing apparel may carry messages which are inspirational. For psychological reasons, the more stimulating the message communicated, the more inspirational the wearer feels. The article of clothing, which may include but is not limited to shirts, pants, dresses, sweaters, suits, hats, is printed or embroidered with a message in a highly visible location. Additionally the message is predetermined by the manufacturer, and the wearer selects an article of clothing from an array of choices. In some cases, t-shirt vendors have provided an opportunity for the consumer to select and imprint the expression they wish to wear.

Accordingly, there is a need for articles of clothing which are fabricated specifically with a religious message. By wearing the article of clothing designed for praying use, the user benefits from a psychological boost. Further, the article of clothing can be adapted for any age group or sex.

### SUMMARY OF THE INVENTION

In accordance with one embodiment, an article of apparel. The article comprises an upper body garment. The upper body garment has a lower opening and an upper opening and is enclosed from all other side. The lower opening provides access for a human upper body to enter within the upper body garment. The upper opening being narrower than the lower body so as to allow only the head and a neck to pass through.

The upper body garment has an outer surface and an inner surface. Wherein, the outer surface forms the exterior part of the garment. The inner surface is towards the human body when worn. The inner surface also has a front and a rear surface. The rear inner surface comprising an erasable surface.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates prayer wear or article of clothing in accordance with an embodiment.

FIG. 2 illustrates the prayer wear with a prayer, spiritual or religious message in accordance with an embodiment.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

In the following detailed description, reference is made to the accompanying drawings which form a part hereof, and in which are shown by way of illustration specific embodiments in which the subject matter disclosed herein may be practiced. These embodiments, which are also referred to herein as “examples,” have been described in sufficient detail to enable those skilled in the art to practice the subject matter disclosed herein. It is to be understood that the embodiments may be combined or that other embodiments may be utilized, and that structural, logical, and other variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

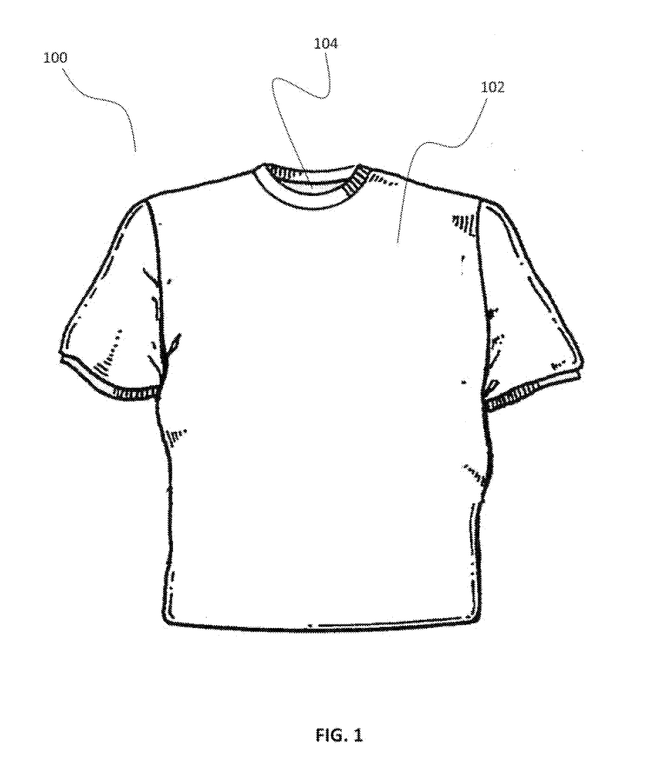

FIG. 1 illustrates prayer wear or article of clothing 100 in accordance with an embodiment. The article of clothing, is limited to upper body garments 100. The figure shows the outer surface 102 and an inner surface 104 of the garment. As shown, the outer surface forms the exterior part of the garment. The inner surface is towards the human body when worn. The inner surface also has a front and a rear surface. The rear inner surface comprising an erasable surface.

In the past the message written in the article of clothing are predetermined by the manufacturer. The subject matter as disclosed herein allows the users of the article of clothing to conveniently rewrite different prayers within the article of clothing. The wearer selects an article of clothing from an array of choices. In some cases, vendors may provide an opportunity for the consumer to select and imprint the expression they wish to wear and then have an option to erase it and write a new passage or prayer.

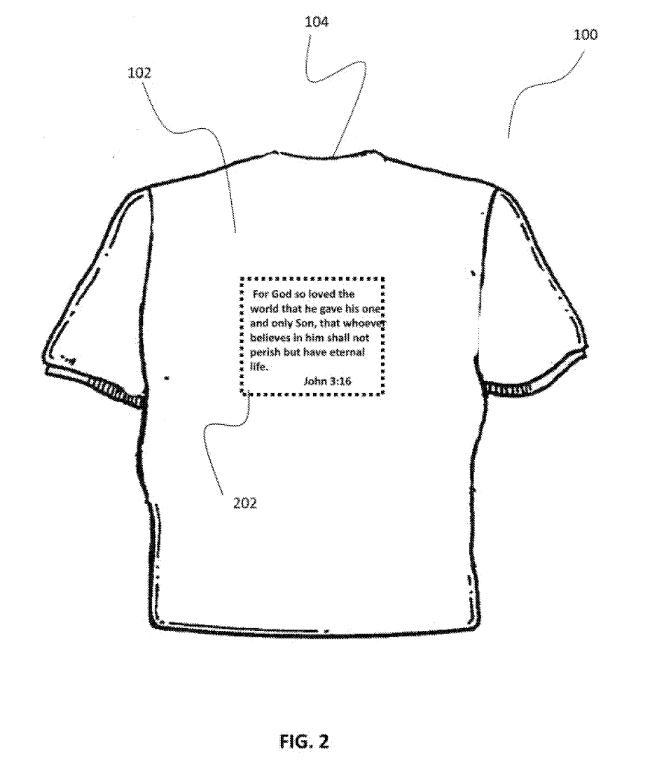

FIG. 2 illustrates the prayer wear with a prayer, spiritual or religious message in accordance with an embodiment. The FIG. 2 shows that the prayer is written within the inside of apparel. The prayer is written on an erasable surface 202.

The written prayer, spiritual or religious message is written on the erasable surface. In one embodiment, the erasable surface may have melamine. The prayer, spiritual or religious message is printed in an orientation that is read from left to right when behind the upper body garment. The written prayer is not visible to anyone when the upper body clothing 100 or the article of clothing is worn. The message is hidden and is only known to the writer and/or wearer. Optionally, the article of apparel may have the prayer, spiritual or religious message is printed on the upper back side of the upper body garment.

In an alternate embodiment, a wearable accessory is provided. This wearable accessory comprises an inner surface and an outer surface. The inner surface of the wearable accessory is one that is hidden from the general view when the accessory is worn. Contrary to the outer surface, which is the wearable surface that is publically viewable when the accessory is worn. Furthermore, the inner surface comprising an erasable surface.

The wearable accessory has a prayer, spiritual or religious message is written on the erasable surface. Also, like the article of the article of apparel the wearable accessory has the erasable surface comprises of a compound melamine. The wearable accessories erasable surface has a prayer, spiritual or religious message.

The wearable accessory of claim 9, wherein the prayer, spiritual or religious message is printed on the upper back side of the upper body garment.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An article of apparel comprising:
an upper body garment, the garment having a body, the body having a lower opening and an upper opening wherein the lower opening provides access for a human upper body to enter within the upper body garment, the upper opening being narrower than the lower body, wherein the upper opening allowing only the head to protrude out of the upper body garment,
the upper body garment having an outer surface and an inner surface, the outer surface forming the exterior of the upper body garment, the inner surface closer to the human body when worn, the inner surface having a front and a rear surface, the rear inner surface comprising an erasable surface.

2. The article of apparel of claim 1, wherein a prayer, spiritual or religious message is written on the erasable surface.

3. The article of apparel of claim 1, wherein the erasable surface is comprises compound melamine.

4. The article of apparel of claim 1, wherein the prayer, spiritual or religious message is printed in an orientation that is read from left to right when behind the upper body garment.

5. The article of apparel of claim 2, wherein the prayer, spiritual or religious message is printed on the upper back side of the upper body garment.

6. The article of apparel of claim 2, wherein the prayer, spiritual or religious message is printed on the upper back of the upper body garment.

7. A method for an article of apparel, the method comprising:
providing an upper body garment, the garment having a body, the body having a lower opening and an upper opening wherein the lower opening providing access for a human upper body to enter within the upper body garment, the upper opening being narrower than the lower body, wherein the upper opening allowing only the head to protrude out of the upper body garment,
the upper body garment having an outer surface and an inner surface, the outer surface forming the exterior of the upper body garment, the inner surface making contact with the human body when worn, the inner surface having a front and a rear surface; and
a prayer, spiritual or religious message is printed on the rear outer surface of the upper body garment, wherein the prayer, spiritual or religious message is printed in an orientation that is read from left to right when behind the upper body garment.

8. A wearable accessory comprising:
the accessory having an inner surface and an outer surface, wherein the inner surface hidden from the general view when the accessory is worn, the inner surface comprising an erasable surface.

9. The wearable accessory of claim 8, wherein a prayer, spiritual or religious message is written on the erasable surface.

10. The wearable accessory of claim 8, wherein the erasable surface is comprises compound melamine.

11. The wearable accessory of claim 9, wherein the prayer, spiritual or religious message is printed in an orientation that is read from left to right when behind the upper body garment.

12. The wearable accessory of claim 9, wherein the prayer, spiritual or religious message is printed on the upper back side of the upper body garment.
